(19) United States
(12) Patent Application Publication
(10) Pub. No.: US 2026/0281412 A1
(43) Pub. Date: Sep. 17, 2026

(54) IMAGE ENCODING/DECODING METHOD AND APPARATUS, AND RECORDING MEDIUM HAVING BITSTREAM STORED THEREIN

(71) Applicant: LG ELECTRONICS INC., Seoul (KR)

(72) Inventors: Chulkeun KIM, Seoul (KR); Hendry TAN, San Diego, CA (US); Jaehyun LIM, Seoul (KR)

(73) Assignee: LG ELECTRONICS INC., Seoul (KR)

(21) Appl. No.: 19/669,813

(22) Filed: May 6, 2026

Related U.S. Application Data
(63) Continuation of application No. PCT/KR2025/004094, filed on Mar. 28, 2025.
(60) Provisional application No. 63/571,463, filed on Mar. 29, 2024.

(51) Int. Cl. H04N 19/46; H04N 19/132; H04N 19/169; H04N 19/172

(52) U.S. Cl. CPC H04N 19/46; H04N 19/132; H04N 19/172; H04N 19/188

(57) ABSTRACT

An image encoding method and apparatus according to the present disclosure can: receive a video picture to be encoded; generate a compressed video picture by encoding the received video picture; generate encoder optimization information; and generate a bitstream including the compressed video picture and the encoder optimization information. Here, the encoder optimization information may include a spatial resampling type flag for identifying a type of spatial resampling applied.

### CROSS-REFERENCE TO RELATED APPLICATIONS

This application is a continuation of International Application No. PCT/KR2025/004094, filed on Mar. 28, 2025, which claims the benefit of U.S. Provisional Application No. 63/571,463, filed on Mar. 29, 2024, the contents of which are all incorporated by reference herein in their entirety.

### TECHNICAL FIELD

The present disclosure relates to an image encoding/decoding method and apparatus, and a recording medium storing a bitstream.

### BACKGROUND

Recently, the demand for high-resolution and high-quality images such as HD (High Definition) images and UHD (Ultra High Definition) images has been increasing in various application fields, and accordingly, highly efficient image compression technologies are being discussed.

There are a variety of technologies such as inter-prediction technology that predicts a pixel value included in a current picture from a picture before or after a current picture with video compression technology, intra-prediction technology that predicts a pixel value included in a current picture by using pixel information in a current picture, entropy coding technology that allocates a short sign to a value with high appearance frequency and a long sign to a value with low appearance frequency, etc. and these image compression technologies may be used to effectively compress image data and transmit or store it.

### SUMMARY

The present disclosure provides a method and an apparatus for configuring encoder optimization information.

The present disclosure provides a method and an apparatus for signaling encoder optimization information.

An image encoding method and apparatus according to the present disclosure may receive a video picture to be encoded, encode the received video picture to generate a compressed video picture, generate encoder optimization information and generate a bitstream including the compressed video picture and the encoder optimization information. Here, the encoder optimization information may be encoded into a network abstraction layer (NAL) unit of the bitstream. The encoder optimization information may include a spatial resampling type flag for identifying a type of applied spatial resampling.

In an image encoding method and apparatus according to the present disclosure, based on the type of the applied spatial resampling being subsampling, the spatial resampling type flag may be encoded as 0, and based on the type of the applied spatial resampling being upsampling, the spatial resampling type flag may be encoded as 1.

In an image encoding method and apparatus according to the present disclosure, the spatial resampling type flag may be generated based on an EOI cancellation flag related to persistence of the encoder optimization information.

In an image encoding method and apparatus according to the present disclosure, based on a value of the EOI cancellation flag being 0, the spatial resampling type flag may be generated, and based on the value of the EOI cancellation flag being 1, the spatial resampling type flag may not be generated.

In an image encoding method and apparatus according to the present disclosure, the spatial resampling type flag may be generated based on a spatial resampling flag related to whether spatial resampling optimization is applied.

In an image encoding method and apparatus according to the present disclosure, based on a value of the spatial resampling flag being 1, the spatial resampling type flag may be generated, and based on the value of the spatial resampling flag being 0, the spatial resampling type flag may not be generated.

In an image encoding method and apparatus according to the present disclosure, the spatial resampling flag may be derived as a value of 0 or 1 based on EOI type information.

In an image encoding method and apparatus according to the present disclosure, the spatial resampling flag may be derived based on EOI type information related to a property of an optimization method.

An image decoding method and apparatus according to the present disclosure may receive a bitstream including an encoded video picture and reconstruct the encoded video picture included in the bitstream. The bitstream may include encoder optimization information, and the encoder optimization information may be obtained from a network abstraction layer (NAL) unit of the bitstream. The encoder optimization information may include a spatial resampling type flag for identifying a type of applied spatial resampling.

A computer-readable digital storage medium storing encoded video/image information that causes performing the image decoding method by a decoding apparatus according to the present disclosure is provided.

A computer-readable digital storage medium storing video/image information generated according to the image encoding method according to the present disclosure is provided.

A method and an apparatus for transmitting video/image information generated according to an image encoding method according to the present disclosure are provided.

According to the present disclosure, the property of applied spatial resampling may be identified by configuring the size information of an original picture into encoder optimization information.

According to the present disclosure, detailed information related to spatial resampling optimization may be efficiently signaled.

### BRIEF DESCRIPTION OF THE DRAWINGS

FIG. 1 shows a video/image coding system according to the present disclosure.

FIG. 2 shows a schematic block diagram of an encoding apparatus to which an embodiment of the present disclosure is applicable and encoding of video/image signals is performed.

FIG. 3 shows a schematic block diagram of a decoding apparatus to which an embodiment of the present disclosure is applicable and decoding of video/image signals is performed.

FIG. 4 illustrates a method for generating a bitstream performed by the encoding apparatus 200 according to the present disclosure.

FIG. 5 illustrates a schematic configuration of the encoding apparatus 200 that performs a method for generating a bitstream according to the present disclosure.

FIG. 6 illustrates a method for reconstructing a video picture performed by the decoding apparatus 300 according to the present disclosure.

FIG. 7 illustrates a schematic configuration of the decoding apparatus 300 that performs a method for reconstructing a video picture according to the present disclosure.

FIG. 8 shows an example of a contents streaming system to which embodiments of the present disclosure may be applied.

### DETAILED DESCRIPTION

Since the present disclosure may make various changes and have several embodiments, specific embodiments will be illustrated in a drawing and described in detail in a detailed description. However, it is not intended to limit the present disclosure to a specific embodiment, and should be understood to include all changes, equivalents and substitutes included in the spirit and technical scope of the present disclosure. While describing each drawing, similar reference numerals are used for similar components.

A term such as first, second, etc. may be used to describe various components, but the components should not be limited by the terms. The terms are used only to distinguish one component from other components. For example, the first component may be referred to as the second component without departing from the scope of a right of the present disclosure, and similarly, the second component may also be referred to as the first component. A term of and/or includes any of a plurality of related stated items or a combination of a plurality of related stated items.

When a component is referred to as “being connected” or “being linked” to another component, it should be understood that it may be directly connected or linked to another component, but another component may exist in the middle. On the other hand, when a component is referred to as “being directly connected” or “being directly linked” to another component, it should be understood that there is no another component in the middle.

A term used in this application is just used to describe a specific embodiment, and is not intended to limit the present disclosure. Singular expressions include plural expressions unless the context clearly dictates otherwise. In this application, it should be understood that a term such as “include” or “have”, etc. is intended to designate the presence of features, numbers, steps, operations, components, parts or combinations thereof described in the specification, but does not exclude in advance the possibility of presence or addition of one or more other features, numbers, steps, operations, components, parts or combinations thereof.

The present disclosure relates to video/image coding. For example, a method/an embodiment disclosed herein may be applied to a method disclosed in the versatile video coding (VVC) standard. In addition, a method/an embodiment disclosed herein may be applied to a method disclosed in the essential video coding (EVC) standard, the AOMedia Video 1 (AV1) standard, the 2nd generation of audio video coding standard (AVS2) or the next-generation video/image coding standard (ex.H.267 or H.268, etc.).

This specification proposes various embodiments of video/image coding, and unless otherwise specified, the embodiments may be performed in combination with each other.

Herein, a video may refer to a set of a series of images over time. A picture generally refers to a unit representing one image in a specific time period, and a slice/a tile is a unit that forms part of a picture in coding. A slice/a tile may include at least one coding tree unit (CTU). One picture may consist of at least one slice/tile. One tile is a rectangular area composed of a plurality of CTUs within a specific tile column and a specific tile row of one picture. A tile column is a rectangular area of CTUs having the same height as that of a picture and a width designated by a syntax requirement of a picture parameter set. A tile row is a rectangular area of CTUs having a height designated by a picture parameter set and the same width as that of a picture. CTUs within one tile may be arranged consecutively according to CTU raster scan, while tiles within one picture may be arranged consecutively according to raster scan of a tile. One slice may include an integer number of complete tiles or an integer number of consecutive complete CTU rows within a tile of a picture that may be included exclusively in a single NAL unit. Meanwhile, one picture may be divided into at least two sub-pictures. A sub-picture may be a rectangular area of at least one slice within a picture.

A pixel, a pixel or a pel may refer to the minimum unit that constitutes one picture (or image). In addition, ‘sample’ may be used as a term corresponding to a pixel. A sample may generally represent a pixel or a pixel value, and may represent only a pixel/a pixel value of a luma component, or only a pixel/a pixel value of a chroma component.

A unit may represent a basic unit of image processing. A unit may include at least one of a specific area of a picture and information related to a corresponding area. One unit may include one luma block and two chroma (ex. cb, cr) blocks. In some cases, a unit may be used interchangeably with a term such as a block or an area, etc. In a general case, a M×N block may include a set (or an array) of transform coefficients or samples (or sample arrays) consisting of M columns and N rows.

Herein, “A or B” may refer to “only A”, “only B” or “both A and B.” In other words, herein, “A or B” may be interpreted as “A and/or B.” For example, herein, “A, B or C” may refer to “only A”, “only B”, “only C” or “any combination of A, B and C)”.

A slash (/) or a comma used herein may refer to “and/or.” For example, “A/B” may refer to “A and/or B.” Accordingly, “A/B” may refer to “only A”, “only B” or “both A and B.” For example, “A, B, C” may refer to “A, B, or C”.

Herein, “at least one of A and B” may refer to “only A”, “only B” or “both A and B”. In addition, herein, an expression such as “at least one of A or B” or “at least one of A and/or B” may be interpreted in the same way as “at least one of A and B”.

In addition, herein, “at least one of A, B and C” may refer to “only A”, “only B”, “only C”, or “any combination of A, B and C”. In addition, “at least one of A, B or C” or “at least one of A, B and/or C” may refer to “at least one of A, B and C”.

In addition, a parenthesis used herein may refer to “for example.” Specifically, when indicated as “prediction (intra prediction)”, “intra prediction” may be proposed as an example of “prediction”. In other words, “prediction” herein is not limited to “intra prediction” and “intra prediction” may be proposed as an example of “prediction.” In addition, even when indicated as “prediction (i.e., intra prediction)”, “intra prediction” may be proposed as an example of “prediction.”

Herein, a technical feature described individually in one drawing may be implemented individually or simultaneously.

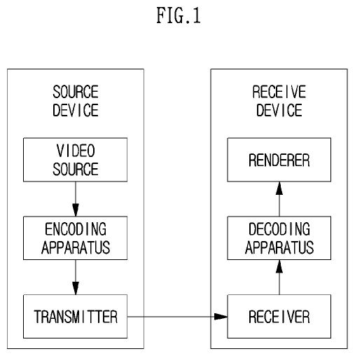

FIG. 1 shows a video/image coding system according to the present disclosure.

Referring to FIG. 1, a video/image coding system may include the first device (a source device) and the second device (a receiving device).

A source device may transmit encoded video/image information or data in a form of a file or streaming to a receiving device through a digital storage medium or a network. The source device may include a video source, an encoding apparatus and a transmission unit. The receiving device may include a reception unit, a decoding apparatus and a renderer. The encoding apparatus may be referred to as a video/image encoding apparatus and the decoding apparatus may be referred to as a video/image decoding apparatus. A transmitter may be included in an encoding apparatus. A receiver may be included in a decoding apparatus. A renderer may include a display unit, and a display unit may be composed of a separate device or an external component.

A video source may acquire a video/an image through a process of capturing, synthesizing or generating a video/an image. A video source may include a device of capturing a video/an image and a device of generating a video/an image. A device of capturing a video/an image may include at least one camera, a video/image archive including previously captured videos/images, etc. A device of generating a video/an image may include a computer, a tablet, a smartphone, etc. and may (electronically) generate a video/an image. For example, a virtual video/image may be generated through a computer, etc., and in this case, a process of capturing a video/an image may be replaced by a process of generating related data.

An encoding apparatus may encode an input video/image. An encoding apparatus may perform a series of procedures such as prediction, transform, quantization, etc. for compression and coding efficiency. Encoded data (encoded video/image information) may be output in a form of a bitstream.

A transmission unit may transmit encoded video/image information or data output in a form of a bitstream to a reception unit of a receiving device through a digital storage medium or a network in a form of a file or streaming. A digital storage medium may include various storage media such as USB, SD, CD, DVD, Blu-ray, HDD, SSD, etc. A transmission unit may include an element for generating a media file through a predetermined file format and may include an element for transmission through a broadcasting/communication network. A reception unit may receive/extract the bitstream and transmit it to a decoding apparatus.

A decoding apparatus may decode a video/an image by performing a series of procedures such as dequantization, inverse transform, prediction, etc. corresponding to an operation of an encoding apparatus.

A renderer may render a decoded video/image. A rendered video/image may be displayed through a display unit.

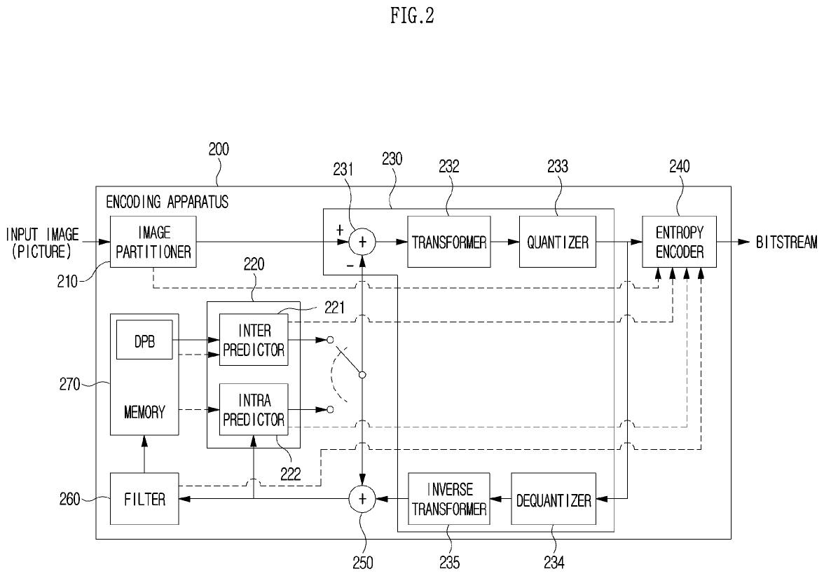

FIG. 2 shows a rough block diagram of an encoding apparatus to which an embodiment of the present disclosure may be applied and encoding of a video/image signal is performed.

Referring to FIG. 2, an encoding apparatus 200 may be composed of an image partitioner 210, a predictor 220, a residual processor 230, an entropy encoder 240, an adder 250, a filter 260 and a memory 270. A predictor 220 may include an inter predictor 221 and an intra predictor 222. A residual processor 230 may include a transformer 232, a quantizer 233, a dequantizer 234 and an inverse transformer 235. A residual processor 230 may further include a subtractor 231. An adder 250 may be referred to as a reconstructor or a reconstructed block generator. The above-described image partitioner 210, predictor 220, residual processor 230, entropy encoder 240, adder 250 and filter 260 may be configured by at least one hardware component (e.g., an encoder chipset or a processor) according to an embodiment. In addition, a memory 270 may include a decoded picture buffer (DPB) and may be configured by a digital storage medium. The hardware component may further include a memory 270 as an internal/external component.

An image partitioner 210 may partition an input image (or picture, frame) input to an encoding apparatus 200 into at least one processing unit. As an example, the processing unit may be referred to as a coding unit (CU). In this case, a coding unit may be partitioned recursively according to a quad-tree binary-tree ternary-tree (QTBTTT) structure from a coding tree unit (CTU) or the largest coding unit (LCU).

For example, one coding unit may be partitioned into a plurality of coding units with a deeper depth based on a quad tree structure, a binary tree structure and/or a ternary structure. In this case, for example, a quad tree structure may be applied first and a binary tree structure and/or a ternary structure may be applied later. Alternatively, a binary tree structure may be applied before a quad tree structure. A coding procedure according to this specification may be performed based on a final coding unit that is no longer partitioned. In this case, based on coding efficiency, etc. according to an image characteristic, the largest coding unit may be directly used as a final coding unit, or if necessary, a coding unit may be recursively partitioned into coding units of a deeper depth, and a coding unit with an optimal size may be used as a final coding unit. Here, a coding procedure may include a procedure such as prediction, transform, and reconstruction, etc. described later.

As another example, the processing unit may further include a prediction unit (PU) or a transform unit (TU). In this case, the prediction unit and the transform unit may be divided or partitioned from a final coding unit described above, respectively. The prediction unit may be a unit of sample prediction, and the transform unit may be a unit for deriving a transform coefficient and/or a unit for deriving a residual signal from a transform coefficient.

In some cases, a unit may be used interchangeably with a term such as a block or an area, etc. In a general case, a M×N block may represent a set of transform coefficients or samples consisting of M columns and N rows. A sample may generally represent a pixel or a pixel value, and may represent only a pixel/a pixel value of a luma component, or only a pixel/a pixel value of a chroma component. A sample may be used as a term that makes one picture (or image) correspond to a pixel or a pel.

An encoding apparatus 200 may subtract a prediction signal (a prediction block, a prediction sample array) output from an inter predictor 221 or an intra predictor 222 from an input image signal (an original block, an original sample array) to generate a residual signal (a residual signal, a residual sample array), and a generated residual signal is transmitted to a transformer 232. In this case, a unit that subtracts a prediction signal (a prediction block, a prediction sample array) from an input image signal (an original block, an original sample array) within an encoding apparatus 200 may be referred to as a subtractor 231.

A predictor 220 may perform prediction on a block to be processed (hereinafter, referred to as a current block) and generate a predicted block including prediction samples for the current block. A predictor 220 may determine whether intra prediction or inter prediction is applied in a unit of a current block or a CU. A predictor 220 may generate various information on prediction such as prediction mode information, etc. and transmit it to an entropy encoder 240 as described later in a description of each prediction mode. Information on prediction may be encoded in an entropy encoder 240 and output in a form of a bitstream.

An intra predictor 222 may predict a current block by referring to samples within a current picture. The samples referred to may be positioned in the neighborhood of the current block or may be positioned a certain distance away from the current block according to a prediction mode. In intra prediction, prediction modes may include at least one nondirectional mode and a plurality of directional modes. A nondirectional mode may include at least one of a DC mode or a planar mode. A directional mode may include 33 directional modes or 65 directional modes according to a detail level of a prediction direction. However, it is an example, and more or less directional modes may be used according to a configuration. An intra predictor 222 may determine a prediction mode applied to a current block by using a prediction mode applied to a neighboring block.

An inter predictor 221 may derive a prediction block for a current block based on a reference block (a reference sample array) specified by a motion vector on a reference picture. In this case, in order to reduce the amount of motion information transmitted in an inter prediction mode, motion information may be predicted in a unit of a block, a sub-block or a sample based on the correlation of motion information between a neighboring block and a current block. The motion information may include a motion vector and a reference picture index. The motion information may further include inter prediction direction information (L0 prediction, L1 prediction, Bi prediction, etc.). For inter prediction, a neighboring block may include a spatial neighboring block existing in a current picture and a temporal neighboring block existing in a reference picture. A reference picture including the reference block and a reference picture including the temporal neighboring block may be the same or different. The temporal neighboring block may be referred to as a collocated reference block, a collocated CU (colCU), etc., and a reference picture including the temporal neighboring block may be referred to as a collocated picture (colPic). For example, an inter predictor 221 may configure a motion information candidate list based on neighboring blocks and generate information indicating which candidate is used to derive a motion vector and/or a reference picture index of the current block. Inter prediction may be performed based on various prediction modes, and for example, for a skip mode and a merge mode, an inter predictor 221 may use motion information of a neighboring block as motion information of a current block. For a skip mode, unlike a merge mode, a residual signal may not be transmitted. For a motion vector prediction (MVP) mode, a motion vector of a neighboring block is used as a motion vector predictor and a motion vector difference is signaled to indicate a motion vector of a current block.

A predictor 220 may generate a prediction signal based on various prediction methods described later. For example, a predictor may not only apply intra prediction or inter prediction for prediction for one block, but also may apply intra prediction and inter prediction simultaneously. It may be referred to as a combined inter and intra prediction (CIIP) mode. In addition, a predictor may be based on an intra block copy (IBC) prediction mode or may be based on a palette mode for prediction for a block. The IBC prediction mode or palette mode may be used for content image/video coding of a game, etc. such as screen content coding (SCC), etc. IBC basically performs prediction within a current picture, but it may be performed similarly to inter prediction in that it derives a reference block within a current picture. In other words, IBC may use at least one of inter prediction techniques described herein. A palette mode may be considered as an example of intra coding or intra prediction. When a palette mode is applied, a sample value within a picture may be signaled based on information on a palette table and a palette index. A prediction signal generated through the predictor 220 may be used to generate a reconstructed signal or a residual signal.

A transformer 232 may generate transform coefficients by applying a transform technique to a residual signal. For example, a transform technique may include at least one of Discrete Cosine Transform (DCT), Discrete Sine Transform (DST), Karhunen-Loève Transform (KLT), Graph-Based Transform (GBT) or Conditionally Non-linear Transform (CNT). Here, GBT refers to transform obtained from this graph when relationship information between pixels is expressed as a graph. CNT refers to transform obtained based on generating a prediction signal by using all previously reconstructed pixels. In addition, a transform process may be applied to a square pixel block in the same size or may be applied to a non-square block in a variable size.

A quantizer 233 may quantize transform coefficients and transmit them to an entropy encoder 240 and an entropy encoder 240 may encode a quantized signal (information on quantized transform coefficients) and output it as a bitstream. Information on the quantized transform coefficients may be referred to as residual information. A quantizer 233 may reorder quantized transform coefficients in a block form into a 1D vector form based on coefficient scan order, and may generate information on the quantized transform coefficients based on the quantized transform coefficients in the 1D vector form.

An entropy encoder 240 may perform various encoding methods such as exponential Golomb, context-adaptive variable length coding (CAVLC), context-adaptive binary arithmetic coding (CABAC), etc. An entropy encoder 240 may encode information necessary for video/image reconstruction (e.g., a value of syntax elements, etc.) other than quantized transform coefficients together or separately.

Encoded information (ex. encoded video/image information) may be transmitted or stored in a unit of a network abstraction layer (NAL) unit in a bitstream form. The video/image information may further include information on various parameter sets such as an adaptation parameter set (APS), a picture parameter set (PPS), a sequence parameter set (SPS) or a video parameter set (VPS), etc. In addition, the video/image information may further include general constraint information. Herein, information and/or syntax elements transmitted/signaled from an encoding apparatus to a decoding apparatus may be included in video/image information. The video/image information may be encoded through the above-described encoding procedure and included in the bitstream. The bitstream may be transmitted through a network or may be stored in a digital storage medium. Here, a network may include a broadcasting network and/or a communication network, etc. and a digital storage medium may include various storage media such as USB, SD, CD, DVD, Blu-ray, HDD, SSD, etc. A transmission unit (not shown) for transmitting and/or a storage unit (not shown) for storing a signal output from an entropy encoder 240 may be configured as an internal/external element of an encoding apparatus 200, or a transmission unit may be also included in an entropy encoder 240.

Quantized transform coefficients output from a quantizer 233 may be used to generate a prediction signal. For example, a residual signal (a residual block or residual samples) may be reconstructed by applying dequantization and inverse transform to quantized transform coefficients through a dequantizer 234 and an inverse transformer 235. An adder 250 may add a reconstructed residual signal to a prediction signal output from an inter predictor 221 or an intra predictor 222 to generate a reconstructed signal (a reconstructed picture, a reconstructed block, a reconstructed sample array). When there is no residual for a block to be processed like when a skip mode is applied, a predicted block may be used as a reconstructed block. An adder 250 may be referred to as a reconstructor or a reconstructed block generator. A generated reconstructed signal may be used for intra prediction of a next block to be processed within a current picture, and may be also used for inter prediction of a next picture through filtering as described later. Meanwhile, luma mapping with chroma scaling (LMCS) may be applied in a picture encoding and/or reconstruction process.

A filter 260 may improve subjective/objective image quality by applying filtering to a reconstructed signal. For example, a filter 260 may generate a modified reconstructed picture by applying various filtering methods to a reconstructed picture, and may store the modified reconstructed picture in a memory 270, specifically in a DPB of a memory 270. The various filtering methods may include deblocking filtering, sample adaptive offset, adaptive loop filter, bilateral filter, etc. A filter 260 may generate various information on filtering and transmit it to an entropy encoder 240. Information on filtering may be encoded in an entropy encoder 240 and output in a form of a bitstream.

A modified reconstructed picture transmitted to a memory 270 may be used as a reference picture in an inter predictor 221. When inter prediction is applied through it, an encoding apparatus may avoid prediction mismatch in an encoding apparatus 200 and a decoding apparatus, and may also improve encoding efficiency.

A DPB of a memory 270 may store a modified reconstructed picture to use it as a reference picture in an inter predictor 221. A memory 270 may store motion information of a block from which motion information in a current picture is derived (or encoded) and/or motion information of blocks in a pre-reconstructed picture. The stored motion information may be transmitted to an inter predictor 221 to be used as motion information of a spatial neighboring block or motion information of a temporal neighboring block. A memory 270 may store reconstructed samples of reconstructed blocks in a current picture and transmit them to an intra predictor 222.

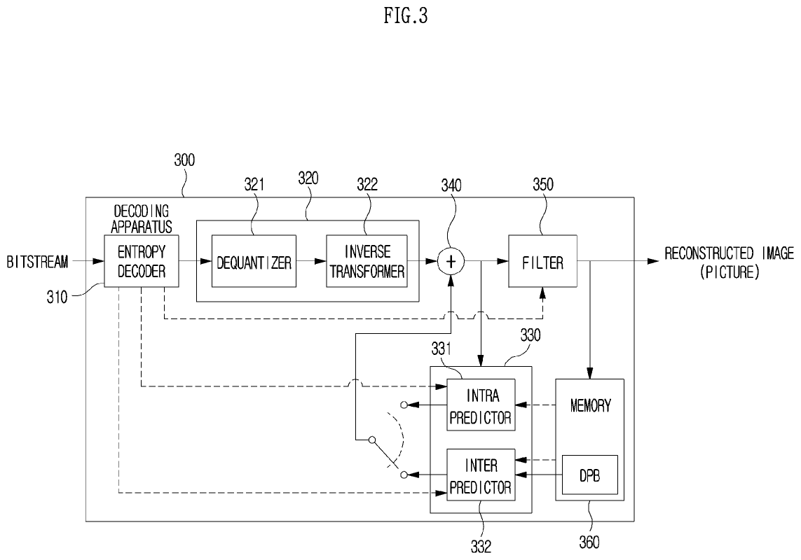

FIG. 3 shows a rough block diagram of a decoding apparatus to which an embodiment of the present disclosure may be applied and decoding of a video/image signal is performed.

Referring to FIG. 3, a decoding apparatus 300 may be configured by including an entropy decoder 310, a residual processor 320, a predictor 330, an adder 340, a filter 350 and a memory 360. A predictor 330 may include an inter predictor 332 and an intra predictor 331. A residual processor 320 may include a dequantizer 321 and an inverse transformer 321.

According to an embodiment, the above-described entropy decoder 310, residual processor 320, predictor 330, adder 340 and filter 350 may be configured by one hardware component (e.g., a decoder chipset or a processor). In addition, a memory 360 may include a decoded picture buffer (DPB) and may be configured by a digital storage medium. The hardware component may further include a memory 360 as an internal/external component.

When a bitstream including video/image information is input, a decoding apparatus 300 may reconstruct an image in response to a process in which video/image information is processed in an encoding apparatus of FIG. 2. For example, a decoding apparatus 300 may derive units/blocks based on block partition-related information obtained from the bitstream. A decoding apparatus 300 may perform decoding by using a processing unit applied in an encoding apparatus. Accordingly, a processing unit of decoding may be a coding unit, and a coding unit may be partitioned from a coding tree unit or the largest coding unit according to a quad tree structure, a binary tree structure and/or a ternary tree structure. At least one transform unit may be derived from a coding unit. And, a reconstructed image signal decoded and output through a decoding apparatus 300 may be played through a playback device.

A decoding apparatus 300 may receive a signal output from an encoding apparatus of FIG. 2 in a form of a bitstream, and a received signal may be decoded through an entropy decoder 310. For example, an entropy decoder 310 may parse the bitstream to derive information (ex. video/image information) necessary for image reconstruction (or picture reconstruction). The video/image information may further include information on various parameter sets such as an adaptation parameter set (APS), a picture parameter set (PPS), a sequence parameter set (SPS) or a video parameter set (VPS), etc. In addition, the video/image information may further include general constraint information. A decoding apparatus may decode a picture further based on information on the parameter set and/or the general constraint information. Signaled/received information and/or syntax elements described later herein may be decoded through the decoding procedure and obtained from the bitstream. For example, an entropy decoder 310 may decode information in a bitstream based on a coding method such as exponential Golomb encoding, CAVLC, CABAC, etc. and output a value of a syntax element necessary for image reconstruction and quantized values of a transform coefficient regarding a residual. In more detail, a CABAC entropy decoding method may receive a bin corresponding to each syntax element from a bitstream, determine a context model by using syntax element information to be decoded, decoding information of a neighboring block and a block to be decoded or information of a symbol/a bin decoded in a previous step, perform arithmetic decoding of a bin by predicting a probability of occurrence of a bin according to a determined context model and generate a symbol corresponding to a value of each syntax element. In this case, a CABAC entropy decoding method may update a context model by using information on a decoded symbol/bin for a context model of a next symbol/bin after determining a context model. Among information decoded in an entropy decoder 310, information on prediction is provided to a predictor (an inter predictor 332 and an intra predictor 331), and a residual value on which entropy decoding was performed in an entropy decoder 310, i.e., quantized transform coefficients and related parameter information may be input to a residual processor 320. A residual processor 320 may derive a residual signal (a residual block, residual samples, a residual sample array). In addition, information on filtering among information decoded in an entropy decoder 310 may be provided to a filter 350. Meanwhile, a reception unit (not shown) that receives a signal output from an encoding apparatus may be further configured as an internal/external element of a decoding apparatus 300 or a reception unit may be a component of an entropy decoder 310.

Meanwhile, a decoding apparatus according to this specification may be referred to as a video/image/picture decoding apparatus, and the decoding apparatus may be divided into an information decoder (a video/image/picture information decoder) and a sample decoder (a video/image/picture sample decoder). The information decoder may include the entropy decoder 310 and the sample decoder may include at least one of dequantizer 321, the inverse transformer 322, the adder 340, the filter 350, the memory 360, the inter predictor 332 and the intra predictor 331.

A dequantizer 321 may dequantize quantized transform coefficients and output transform coefficients. A dequantizer 321 may reorder quantized transform coefficients into a two-dimensional block form. In this case, the reordering may be performed based on coefficient scan order performed in an encoding apparatus. A dequantizer 321 may perform dequantization on quantized transform coefficients by using a quantization parameter (e.g., quantization step size information) and obtain transform coefficients.

An inverse transformer 322 inversely transforms transform coefficients to obtain a residual signal (a residual block, a residual sample array).

A predictor 320 may perform prediction on a current block and generate a predicted block including prediction samples for the current block. A predictor 320 may determine whether intra prediction or inter prediction is applied to the current block based on the information on prediction output from an entropy decoder 310 and determine a specific intra/inter prediction mode.

A predictor 320 may generate a prediction signal based on various prediction methods described later. For example, a predictor 320 may not only apply intra prediction or inter prediction for prediction for one block, but also may apply intra prediction and inter prediction simultaneously. It may be referred to as a combined inter and intra prediction (CIIP) mode. In addition, a predictor may be based on an intra block copy (IBC) prediction mode or may be based on a palette mode for prediction for a block. The IBC prediction mode or palette mode may be used for content image/video coding of a game, etc. such as screen content coding (SCC), etc. IBC basically performs prediction within a current picture, but it may be performed similarly to inter prediction in that it derives a reference block within a current picture. In other words, IBC may use at least one of inter prediction techniques described herein. A palette mode may be considered as an example of intra coding or intra prediction. When a palette mode is applied, information on a palette table and a palette index may be included in the video/image information and signaled.

An intra predictor 331 may predict a current block by referring to samples within a current picture. The samples referred to may be positioned in the neighborhood of the current block or may be positioned a certain distance away from the current block according to a prediction mode. In intra prediction, prediction modes may include at least one nondirectional mode and a plurality of directional modes. An intra predictor 331 may determine a prediction mode applied to a current block by using a prediction mode applied to a neighboring block.

An inter predictor 332 may derive a prediction block for a current block based on a reference block (a reference sample array) specified by a motion vector on a reference picture. In this case, in order to reduce the amount of motion information transmitted in an inter prediction mode, motion information may be predicted in a unit of a block, a sub-block or a sample based on the correlation of motion information between a neighboring block and a current block. The motion information may include a motion vector and a reference picture index. The motion information may further include inter prediction direction information (L0 prediction, L1 prediction, Bi prediction, etc.). For inter prediction, a neighboring block may include a spatial neighboring block existing in a current picture and a temporal neighboring block existing in a reference picture. For example, an inter predictor 332 may configure a motion information candidate list based on neighboring blocks and derive a motion vector and/or a reference picture index of the current block based on received candidate selection information. Inter prediction may be performed based on various prediction modes, and the information on prediction may include information indicating an inter prediction mode for the current block.

An adder 340 may add an obtained residual signal to a prediction signal (a prediction block, a prediction sample array) output from a predictor (including an inter predictor 332 and/or an intra predictor 331) to generate a reconstructed signal (a reconstructed picture, a reconstructed block, a reconstructed sample array). When there is no residual for a block to be processed like when a skip mode is applied, a prediction block may be used as a reconstructed block.

An adder 340 may be referred to as a reconstructor or a reconstructed block generator. A generated reconstructed signal may be used for intra prediction of a next block to be processed in a current picture, may be output through filtering as described later or may be used for inter prediction of a next picture. Meanwhile, luma mapping with chroma scaling (LMCS) may be applied in a picture decoding process.

A filter 350 may improve subjective/objective image quality by applying filtering to a reconstructed signal. For example, a filter 350 may generate a modified reconstructed picture by applying various filtering methods to a reconstructed picture and transmit the modified reconstructed picture to a memory 360, specifically a DPB of a memory 360. The various filtering methods may include deblocking filtering, sample adaptive offset, adaptive loop filter, bilateral filter, etc.

The (modified) reconstructed picture stored in the DPB of the memory 360 can be used as a reference picture in the inter predictor 332. A memory 360 may store motion information of a block from which motion information in a current picture is derived (or decoded) and/or motion information of blocks in a pre-reconstructed picture. The stored motion information may be transmitted to an inter predictor 332 to be used as motion information of a spatial neighboring block or motion information of a temporal neighboring block. A memory 360 may store reconstructed samples of reconstructed blocks in a current picture and transmit them to an intra predictor 331.

Herein, embodiments described in a filter 260, an inter predictor 221 and an intra predictor 222 of an encoding apparatus 200 may be also applied equally or correspondingly to a filter 350, an inter predictor 332 and an intra predictor 331 of a decoding apparatus 300, respectively.

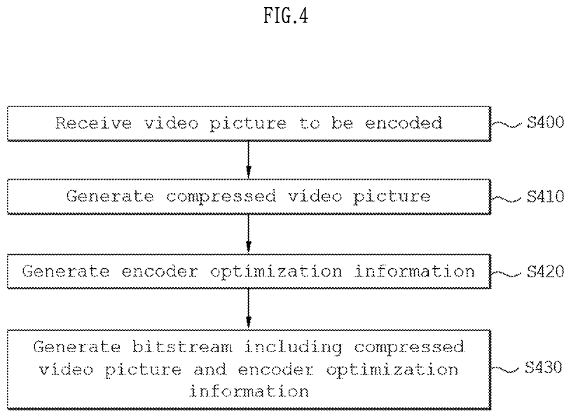

FIG. 4 illustrates a method for generating a bitstream performed by the encoding apparatus 200 according to the present disclosure.

A video picture to be encoded may be received S400.

A received video picture may be encoded to generate a compressed video picture S410.

Encoder optimization information (EOI) may be generated S420.

Encoder optimization information according to the present disclosure may relate to a received or compressed video picture. Encoder optimization information may define the purpose, property and application scope (or, target) of encoder optimization.

As an example, encoder optimization information may include an EOI cancellation flag (eoi_cancel_flag). eoi_cancel_flag may relate to the persistence of encoder optimization information. When the value of eoi_cancel_flag is 1, it may represent that the persistence of previously applied encoder optimization information is canceled. For example, when the value of eoi_cancel_flag is 1, it may represent that the persistence of encoder optimization information included in a previous prediction unit (PU) in an output order is canceled. When the value of eoi_cancel_flag is 0, it may represent that optimization-related information applied during pre-processing or encoding follows.

The optimization-related information may include at least one of an EOI persistence flag (eoi_persistence_flag), an EOI identifier for human viewing (eoi_for_human_viewing_idc), an EOI identifier for machine analysis (eoi_for_machine_analysis_idc) or EOI type information (eoi_type). In other words, based on the value of eoi_cancel_flag being 0, the above-described optimization-related information may be encoded.

eoi_persistence_flag may relate to the persistence of optimization information. eoi_persistence_flag may represent the persistence of optimization information represented by eoi_type. When the value of eoi_persistence_flag is 0, it may represent that optimization information (identified based on eoi_type) is applied only to a current picture. When the value of eoi_persistence_flag is 1, it may represent that optimization information (identified based on eoi_type) is applied to a current picture and all subsequent pictures. Here, subsequent pictures may refer to all subsequent pictures of a current layer in an output order.

eoi_for_human_viewing_idc may represent information for identifying the purpose and target of optimization. When the value of eoi_for_human_viewing_idc is 3, it may mean that the purpose of optimization includes human viewing. When the value of eoi_for_human_viewing_idc is 2, it may mean that a video is suitable for human viewing, but is not specifically optimized for human viewing. When the value of eoi_for_human_viewing_idc is 1, it may mean that a video is not suitable for human viewing. When the value of eoi_for_human_viewing_idc is 0, it may mean that it is not known whether a video is suitable for human viewing.

eoi_for_machine_analysis_idc may represent information for identifying the purpose and target of optimization. When the value of eoi_for_machine_analysis_idc is 3, it may mean that the purpose of optimization includes machine analysis. When the value of eoi_for_machine_analysis_idc is 2, it may mean that a video is suitable for machine analysis, but is not specifically optimized for machine analysis. When the value of eoi_for_machine_analysis_idc is 1, it may mean that a video is not suitable for machine analysis. When the value of eoi_for_machine_analysis_idc is 0, it may mean that it is not known whether a video is suitable for machine analysis.

eoi_type may represent the property of an optimization method. For example, eoi_type may be defined as in Table 1 below. eoi_type may identify an optimization property (or an optimization type) defined in Table 1. However, an optimization property defined in Table 1 is just an example, and a new optimization property may also be defined under a corresponding structure. Alternatively, eoi_type may identify only a part of an optimization property defined in Table 1. Other optimization properties not defined in Table 1 may also be defined additionally in Table 1.

TABLE 1

| bitMask | Interpretation |
|---|---|
| 0x01 | Object-based optimization; the pictures for which this SEI message persists have |
| | been pre-processed or encoded so that detected objects in the pictures are |
| | optimized with respect to other parts of the pictures for the indicated optimization |
| | purposes |
| 0x02 | Temporal resampling optimization |
| 0x04 | Spatial resampling optimization |
| 0x08 | Temporal quality optimization |
| 0x10 | Spatial quality optimization; the pictures for which this SEI message persists have |
| | been pre-processed or encoded to reduce unnecessary information or improve the |
| | quality of necessary information.(e.g to reduce the amount of noise and remove |
| | speckles at the picture-level) |
| 0x20 | personal information protection optimization; the pictures for which this SEI |
| | message persists have been pre-processed or encoded to protect personal |
| | information. (e.g. removal or replacing of personal identifiable information, |
| | pseudonymization, anonymization) |

When (eoi_type & bitMask) is not 0, it may represent that an optimization property with a bitMask value in Table 1 is applied. When eoi_type is greater than 0 and (eoi_type & bitMask) is 0, it may represent that an optimization property with a corresponding bitMask value is not applied. When eoi_type is 0, it may represent that optimization determined by an application is used. For example, an optimization property according to eoi_type may also be defined as in Table 2 below.

TABLE 2

| Value | Interpretation |
|---|---|
| eoi_type = = 0 | May be used as determined by the application |
| eoi_type > 0 && | No object-based optimization |
| ( eoi_type & | |
| 0x01 ) = = 0 | |
| ( eoi_type & | With object-based optimization |
| 0x01 ) != 0 | |
| eoi_type > 0 && | No temporal resampling optimization |
| ( eoi_type & | |
| 0x02 ) = = 0 | |
| ( eoi_type & | With temporal resampling optimization |
| 0x02 ) != 0 | |
| eoi_type > 0 && | No spatial resampling optimization |
| ( eoi_type & | |
| 0x04 ) = = 0 | |
| ( eoi_type & | With spatial resampling optimization |
| 0x04 ) != 0 | |
| eoi_type > 0 && | No temporal quality optimization |
| ( eoi_type & | |
| 0x08 ) = = 0 | |
| ( eoi_type & | With temporal quality optimization |
| 0x08 ) != 0 | |
| eoi_type > 0 && | No spatial quality optimization |
| ( eoi_type & | |
| 0x10 ) = = 0 | |
| ( eoi_type & | With spatial quality optimization; the pictures for which this SEI |
| 0x10 ) != 0 | message persists have been pre-processed or encoded to reduce |
| | unnecessary information or improve the quality of necessary |
| | information.(e.g to reduce the amount of noise and remove speckles |
| | at the picture-level) |
| eoi_type > 0 && | No optimization for personal information protection |
| ( eoi_type & | |
| 0x20 ) == 0 | |
| ( eoi_type & | With personal information protection optimization; the pictures for |
| 0x20 ) != 0 | which this SEI message persists have been pre-processed or encoded |
| | to protect personal information. (e.g. removal or replacing of |
| | personal identifiable information, pseudonymization, |
| | anonymization) |

Encoder optimization information related to the purpose, property and application scope of optimization described above may also be applied equally to embodiments to be described below. Encoder optimization information may be defined in an SEI message, as in Table 3 below.

TABLE 3

| | Descriptor |
|---|---|
| encoder_optimization_info(payloadSize ) { | |
| eoi_cancel_flag | u(1) |
| if(!eoi_cancel_flag){ | |
| eoi_persistence_flag | u(1) |
| eoi_for_human_viewing_idc | u(2) |
| eoi_for_machine_analysis_idc | u(2) |
| eoi_type | u(16) |
| } | |
| } | |

An applied optimization property may be derived based on information in Table 1 or Table 2. Based on eoi_type, an applied optimization property may be identified, and detailed information related to an applied optimization property may be additionally defined in encoder optimization information.

As an example, a spatial resampling flag (EoiSpatialResamplingFlag) may represent whether spatial resampling optimization is applied. When the value of EoiSpatialResamplingFlag is 1, it may mean that spatial resampling is applied. When the value of EoiSpatialResamplingFlag is 0, it may mean that spatial resampling is not applied. The value of EoiSpatialResamplingFlag may be derived based on eoi_type as in Equation 1 or 2 below.

$$EoiSpatialResamplingFlag = ( eoi\_type \& 0 x 04 ) > 0 ) ? 1 : 0 \qquad [ Equation 1 ]$$

$$if ( ( eoi\_type \& 0 x 04 ) != 0 ) \\ EoiSpatialResamplingFlag = 1 ; \\ else \\ EoiSpatialResamplingFlag = 0 ; \qquad [ Equation 2 ]$$

In other words, when the value of (eoi_type & 0x04) is greater than 0, the value of EoiSpatialResamplingFlag may be derived as 1, and otherwise, the value of EoiSpatialResamplingFlag may be derived as 0. Alternatively, when the value of (eoi_type & 0x04) is not 0, the value of EoiSpatialResamplingFlag may be derived as 1, and when the value of (eoi_type & 0x04) is 0, the value of EoiSpatialResamplingFlag may be derived as 0.

The present disclosure relates to a method for defining detailed information related to spatial resampling optimization.

Spatial resampling may include subsampling and upsampling. Accordingly, information that may distinguish whether applied spatial resampling optimization is subsampling or upsampling needs to be defined.

As an example of detailed information related to spatial resampling optimization, a spatial resampling type flag (eoi_spatial_resampling_type_flag) may be defined. A spatial resampling type flag may be information for identifying the type of applied spatial resampling.

For example, when the value of eoi_spatial_resampling_type_flag is 0, it may represent that applied spatial resampling optimization is not upsampling. Alternatively, when the value of eoi_spatial_resampling_type_flag is 0, it may represent that applied spatial resampling optimization is subsampling. On the other hand, when the value of eoi_spatial_resampling_type_flag is 1, it may represent that applied spatial resampling optimization is upsampling.

In other words, when applied spatial resampling optimization is not upsampling (or, when applied spatial resampling optimization is subsampling), eoi_spatial_resampling_type_flag with a value of 0 may be generated and encoded. On the other hand, when applied spatial resampling optimization is upsampling, eoi_spatial_resampling_type_flag with a value of 1 may be generated and encoded.

Conversely, when the value of eoi_spatial_resampling_type_flag is 0, it may represent that applied spatial resampling optimization is upsampling. On the other hand, when the value of eoi_spatial_resampling_type_flag is 1, it may represent that applied spatial resampling optimization is not upsampling. Alternatively, when the value of eoi_spatial_resampling_type_flag is 1, it may represent that applied spatial resampling optimization is subsampling.

In other words, when applied spatial resampling optimization is upsampling, eoi_spatial_resampling_type_flag with a value of 0 may be generated and encoded. On the other hand, when applied spatial resampling optimization is not upsampling (or, when applied spatial resampling optimization is subsampling), eoi_spatial_resampling_type_flag with a value of 1 may be generated and encoded.

The width of an original picture may be greater than the width of a decoded picture, while the height of an original picture may be less than or equal to the height of a decoded picture. Conversely, the width of an original picture may be less than the width of a decoded picture, while the height of an original picture may be greater than or equal to the height of a decoded picture. In this way, a different type of resampling may also be applied to a horizontal direction and a vertical direction. Alternatively, resampling may be applied to one of a horizontal or vertical direction and resampling may not be applied to the other.

Accordingly, a spatial resampling type flag may be defined for a horizontal direction and a vertical direction, respectively. A spatial resampling type flag may include a flag related to horizontal spatial resampling optimization (eoi_spatial_resampling_hor_type_flag) and a flag related to vertical spatial resampling optimization (eoi_spatial_resampling_ver_type_flag).

For example, when the value of eoi_spatial_resampling_hor_type_flag is 0, it may represent that spatial resampling optimization is not horizontal upsampling. When the value of eoi_spatial_resampling_hor_type_flag is 1, it may represent that spatial resampling optimization is horizontal upsampling. When the value of eoi_spatial_resampling_ver_type_flag is 0, it may represent that spatial resampling optimization is not vertical upsampling. When the value of eoi_spatial_resampling_ver_type_flag is 1, it may represent that spatial resampling optimization is vertical upsampling.

eoi_spatial_resampling_type_flag according to the present disclosure may be defined as in Table 4 below.

TABLE 4

| | Descriptor |
|---|---|
| encoder_optimization_info(payloadSize ) { | |
| eoi_cancel_flag | u(1) |
| if(!eoi_cancel_flag){ | |
| eoi_persistence_flag | u(1) |
| eoi_for_human_viewing_idc | u(2) |
| eoi_for_machine_analysis_idc | u(2) |
| eoi_type | u(16) |
| if(EoiSpatialResamplingFlag){ | |
| eoi_spatial_resampling_type_flag | u(1) |
| } | |
| } | |
| } | |
| } | |

In Table 4, eoi_spatial_resampling_type_flag may be included in encoder optimization information.

It may be generated and encoded into a bitstream based on an EOI cancellation flag (eoi_cancel_flag) related to the persistence of encoder optimization information.

Specifically, eoi_spatial_resampling_type_flag may be generated and may be encoded into a bitstream based on the value of eoi_cancel_flag being 0. eoi_spatial_resampling_type_flag may not be generated and may not be encoded into a bitstream based on the value of eoi_cancel_flag being 1.

In addition, eoi_spatial_resampling_type_flag may be generated and encoded into a bitstream based on a spatial resampling flag (EoiSpatialResamplingFlag) related to whether spatial resampling optimization is applied.

Specifically, eoi_spatial_resampling_type_flag may be generated and may be encoded into a bitstream based on the value of EoiSpatialResamplingFlag being 1. eoi_spatial_resampling_type_flag may not be generated and may not be encoded into a bitstream based on the value of EoiSpatialResamplingFlag being 0.

The value of EoiSpatialResamplingFlag above may be derived based on eoi_type, which is the same as described above.

eoi_spatial_resampling_type_flag may be encoded as a descriptor of u(1). In other words, eoi_spatial_resampling_type_flag may be encoded as an unsigned integer with 1 bit. eoi_spatial_resampling_type_flag according to Table 4 may be expressed as 1 bit as in Table 5 below.

TABLE 5

| eoi_spatial_resampling_type_flag | description |
|---|---|
| 0 | subsampling |
| 1 | upsampling |

A bitstream including the compressed video picture and the encoder optimization information may be generated S430. Encoder optimization information may be configured in the SEI message of a bitstream. An SEI message may be included in the network abstraction layer (NAL) unit of a bitstream.

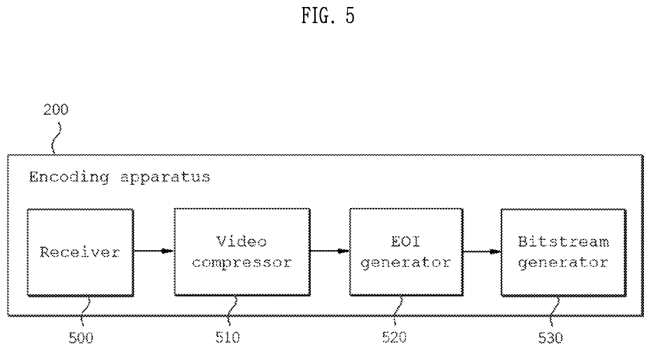

FIG. 5 illustrates a schematic configuration of the encoding apparatus 200 that performs a method for generating a bitstream according to the present disclosure.

Referring to FIG. 5, the encoding apparatus 200 may include the receiver 500, the video compressor 510, the EOI generator 520 and the bitstream generator 530.

The receiver 500 may receive one or more video pictures encoded.

The video compressor 510 may encode one or more received video pictures to generate a compressed video picture.

The EOI generator 520 may generate encoder optimization information.

The bitstream generator 530 may generate a bitstream including a compressed video picture and encoder optimization information.

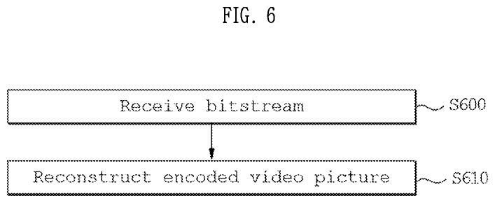

FIG. 6 illustrates a method for reconstructing a video picture performed by the decoding apparatus 300 according to the present disclosure.

A bitstream including an encoded video picture may be received S600.

The encoded video picture of a bitstream may be reconstructed S610.

Video information related to an encoded video picture may be extracted from a bitstream. An encoded video picture may be reconstructed based on extracted video information.

In addition, an SEI message may be included in the NAL unit of a bitstream. Encoder optimization information (EOI) may be defined in an SEI message S420. Encoder optimization information may relate to the encoded video picture. Encoder optimization information may be included in an SEI message and signaled through a bitstream.

The encoder optimization information may include an EOI cancellation flag (eoi_cancel_flag). Based on eoi_cancel_flag being 0, optimization-related information may be included in encoder optimization information, which is the same as described by referring to FIG. 4.

In addition, detailed information related to spatial resampling optimization may be included in encoder optimization information. Detailed information related to spatial resampling optimization may be decoded from a bitstream based on at least one of eoi_cancel_flag or a spatial resampling flag (EoiSpatialResamplingFlag) representing whether spatial resampling optimization is applied.

As an example of detailed information related to spatial resampling optimization, a spatial resampling type flag (eoi_spatial_resampling_type_flag) for identifying the type of applied spatial resampling may be used. As described above, since spatial resampling includes subsampling and upsampling, a spatial resampling type flag needs to be defined to distinguish whether applied spatial resampling optimization is subsampling or upsampling.

Based on an EOI cancellation flag (eoi_cancel_flag) related to the persistence of encoder optimization information, eoi_spatial_resampling_type_flag may be decoded from a bitstream.

For example, eoi_spatial_resampling_type_flag may be decoded from a bitstream based on the value of eoi_cancel_flag being 0. eoi_spatial_resampling_type_flag may not be decoded from a bitstream based on the value of eoi_cancel_flag being 1.

In addition, eoi_spatial_resampling_type_flag may be decoded from a bitstream based on EoiSpatialResamplingFlag related to whether spatial resampling optimization is applied.

For example, eoi_spatial_resampling_type_flag may be decoded from a bitstream based on the value of EoiSpatialResamplingFlag being 1. eoi_spatial_resampling_type_flag may not be decoded from a bitstream based on the value of EoiSpatialResamplingFlag being 0.

As described above, a spatial resampling type flag may be defined for a horizontal direction and a vertical direction, respectively. In this case, eoi_spatial_resampling_type_flag may be understood by being substituted with eoi_spatial_resampling_hor_type_flag and eoi_spatial_resampling_ver_type_flag.

The value of EoiSpatialResamplingFlag above may be derived based on eoi_type, which is the same as described above.

As eoi_spatial_resampling_type_flag is encoded as a descriptor of u(1), it may have the value of an unsigned integer with 1 bit.

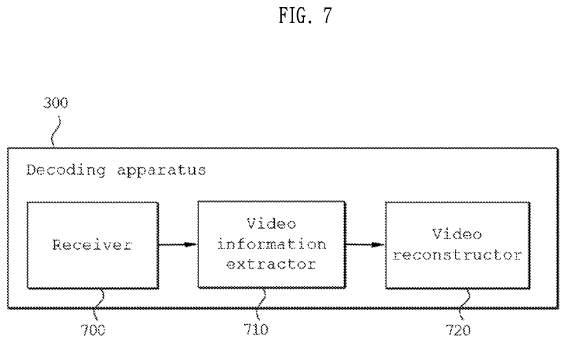

FIG. 7 illustrates a schematic configuration of the decoding apparatus 300 that performs a method for reconstructing a video picture according to the present disclosure.

Referring to FIG. 7, the decoding apparatus 300 may include the receiver 700, the video information extractor 710 and the video reconstructor 720.

The receiver 700 may receive a bitstream including an encoded video picture.

The video information extractor 710 may extract video information related to an encoded video picture from a bitstream. In addition, the video information extractor 710 may extract an SEI message from the NAL unit of a bitstream. An extracted SEI message may include encoder optimization information.

The video reconstructor 720 may reconstruct an encoded video picture based on extracted video information.

In the above-described embodiment, methods are described based on a flowchart as a series of steps or blocks, but a corresponding embodiment is not limited to the order of steps, and some steps may occur simultaneously or in different order with other steps as described above. In addition, those skilled in the art may understand that steps shown in a flowchart are not exclusive, and that other steps may be included or one or more steps in a flowchart may be deleted without affecting the scope of embodiments of the present disclosure.

The above-described method according to embodiments of the present disclosure may be implemented in a form of software, and an encoding apparatus and/or a decoding apparatus according to the present disclosure may be included in a device which performs image processing such as a TV, a computer, a smartphone, a set top box, a display device, etc.

In the present disclosure, when embodiments are implemented as software, the above-described method may be implemented as a module (a process, a function, etc.) that performs the above-described function. A module may be stored in a memory and may be executed by a processor. A memory may be internal or external to a processor, and may be connected to a processor by a variety of well-known means. A processor may include an application-specific integrated circuit (ASIC), another chipset, a logic circuit and/or a data processing device. A memory may include a read-only memory (ROM), a random access memory (RAM), a flash memory, a memory card, a storage medium and/or another storage device. In other words, embodiments described herein may be performed by being implemented on a processor, a microprocessor, a controller or a chip. For example, functional units shown in each drawing may be performed by being implemented on a computer, a processor, a microprocessor, a controller or a chip. In this case, information for implementation (ex. information on instructions) or an algorithm may be stored in a digital storage medium.

In addition, a decoding apparatus and an encoding apparatus to which embodiment(s) of the present disclosure are applied may be included in a multimedia broadcasting transmission and reception device, a mobile communication terminal, a home cinema video device, a digital cinema video device, a surveillance camera, a video conversation device, a real-time communication device like a video communication, a mobile streaming device, a storage medium, a camcorder, a device for providing video on demand (VOD) service, an over the top video (OTT) device, a device for providing Internet streaming service, a three-dimensional (3D) video device, a virtual reality (VR) device, an argumente reality (AR) device, a video phone video device, a transportation terminal (ex. a vehicle (including an autonomous vehicle) terminal, an airplane terminal, a ship terminal, etc.) and a medical video device, etc., and may be used to process a video signal or a data signal. For example, an over the top video (OTT) device may include a game console, a blu-ray player, an Internet-connected TV, a home theater system, a smartphone, a tablet PC, a digital video recorder (DVR), etc.

In addition, a processing method to which embodiment(s) of the present disclosure are applied may be produced in a form of a program executed by a computer and may be stored in a computer-readable recording medium. Multimedia data having a data structure according to embodiment(s) of the present disclosure may be also stored in a computer-readable recording medium. The computer-readable recording medium includes all types of storage devices and distributed storage devices that store computer-readable data. The computer-readable recording medium may include, for example, a blu-ray disk (BD), an universal serial bus (USB), ROM, PROM, EPROM, EEPROM, RAM, CD-ROM, a magnetic tape, a floppy disk and an optical media storage device. In addition, the computer-readable recording medium includes media implemented in a form of a carrier wave (e.g., transmission via the Internet). In addition, a bitstream generated by an encoding method may be stored in a computer-readable recording medium or may be transmitted through a wired or wireless communication network.

In addition, embodiment(s) of the present disclosure may be implemented by a computer program product by a program code, and the program code may be executed on a computer by embodiment(s) of the present disclosure. The program code may be stored on a computer-readable carrier.

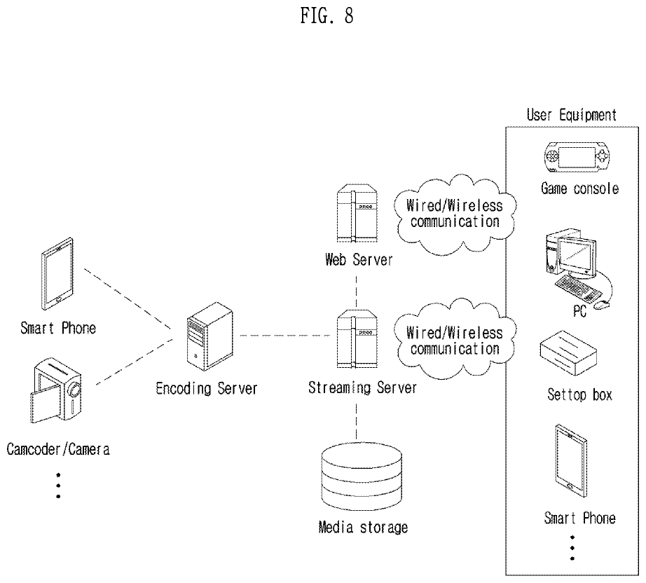

FIG. 8 shows an example of a contents streaming system to which embodiments of the present disclosure may be applied.

Referring to FIG. 8, a contents streaming system to which embodiment(s) of the present disclosure are applied may largely include an encoding server, a streaming server, a web server, a media storage, a user device and a multimedia input device.

The encoding server generates a bitstream by compressing contents input from multimedia input devices such as a smartphone, a camera, a camcorder, etc. into digital data and transmits it to the streaming server. As another example, when multimedia input devices such as a smartphone, a camera, a camcorder, etc. directly generate a bitstream, the encoding server may be omitted.

The bitstream may be generated by an encoding method or a bitstream generation method to which embodiment(s) of the present disclosure are applied, and the streaming server may temporarily store the bitstream in a process of transmitting or receiving the bitstream.

The streaming server transmits multimedia data to a user device based on a user's request through a web server, and the web server serves as a medium to inform a user of what service is available. When a user requests desired service from the web server, the web server delivers it to a streaming server, and the streaming server transmits multimedia data to a user. In this case, the contents streaming system may include a separate control server, and in this case, the control server controls a command/a response between each device in the content streaming system.

The streaming server may receive contents from a media storage and/or an encoding server. For example, when contents is received from the encoding server, the contents may be received in real time. In this case, in order to provide smooth streaming service, the streaming server may store the bitstream for a certain period of time.

An example of the user device may include a mobile phone, a smart phone, a laptop computer, a digital broadcasting terminal, a personal digital assistants (PDAs), a portable multimedia players (PMP), a navigation, a slate PC, a Tablet PC, an ultrabook, a wearable device (e.g., a smartwatch, a smart glass, a head mounted display (HMD), a digital TV, a desktop, a digital signage, etc.

Each server in the contents streaming system may be operated as a distributed server, and in this case, data received from each server may be distributed and processed.

The claims set forth herein may be combined in various ways. For example, a technical characteristic of a method claim of the present disclosure may be combined and implemented as a device, and a technical characteristic of a device claim of the present disclosure may be combined and implemented as a method. In addition, a technical characteristic of a method claim of the present disclosure and a technical characteristic of a device claim may be combined and implemented as a device, and a technical characteristic of a method claim of the present disclosure and a technical characteristic of a device claim may be combined and implemented as a method.

What is claimed is:

1. A method, comprising:
receiving a video picture to be encoded;
encoding the received video picture to generate a compressed video picture;
generating encoder optimization information (EOI); and
generating a bitstream including the compressed video picture and the encoder optimization information,
wherein the encoder optimization information is encoded into a network abstraction layer (NAL) unit of the bitstream, and
wherein the encoder optimization information includes a spatial resampling type flag for identifying a type of applied spatial resampling.

2. The method of claim 1, wherein based on the type of the applied spatial resampling being subsampling, the spatial resampling type flag is encoded as 0, and
wherein based on the type of the applied spatial resampling being upsampling, the spatial resampling type flag is encoded as 1.

3. The method of claim 1, wherein the spatial resampling type flag is generated based on an EOI cancellation flag related to persistence of the encoder optimization information.

4. The method of claim 3, wherein based on a value of the EOI cancellation flag being 0, the spatial resampling type flag is generated, and
wherein based on the value of the EOI cancellation flag being 1, the spatial resampling type flag is not generated.

5. The method of claim 1, wherein the spatial resampling type flag is generated based on a spatial resampling flag related to whether spatial resampling optimization is applied.

6. The method of claim 5, wherein based on a value of the spatial resampling flag being 1, the spatial resampling type flag is generated, and
wherein based on the value of the spatial resampling flag being 0, the spatial resampling type flag is not generated.

7. The method of claim 5, wherein the spatial resampling flag is derived as a value of 0 or 1 based on EOI type information.

8. The method of claim 7, wherein the spatial resampling flag is derived based on EOI type information related to a property of an optimization method.

9. A method, comprising:
receiving a bitstream including an encoded video picture; and
reconstructing the encoded video picture included in the bitstream,
wherein the bitstream includes encoder optimization information (EOI),
wherein the encoder optimization information is obtained from a network abstraction layer (NAL) unit of the bitstream, and
wherein the encoder optimization information includes a spatial resampling type flag for identifying a type of applied spatial resampling.

10. A computer-readable storage medium for storing a bitstream generated by the method according to claim 1.

11. A method, comprising:
generating a bitstream, wherein the bitstream is generated based on receiving a video picture to be encoded, encoding the received video picture to generate a compressed video picture, generating encoder optimization information (EOI), and generating the bitstream including the compressed video picture and the encoder optimization information; and
transmitting data including the bitstream,
wherein the encoder optimization information is encoded into a network abstraction layer (NAL) unit of the bitstream, and
wherein the encoder optimization information includes a spatial resampling type flag for identifying a type of applied spatial resampling.
